(19) United States
(12) Patent Application Publication
(10) Pub. No.: US 2018/0125293 A1
(43) Pub. Date: May 10, 2018

(54) AIR FRYING SYSTEMS AND METHODS

(71) Applicant: Spectrum Brands, Inc., Middleton, WI (US)

(72) Inventors: Gerald Joseph McNerney, Middleton, WI (US); Casey Aaron Klock, Fitchburg, WI (US); Boopalan Sampath, Madison, WI (US); Jacob Daniel Smith, Monona, WI (US); William Kolbe Barron, Madison, WI (US)

(21) Appl. No.: 15/667,250

(22) Filed: Aug. 2, 2017

Related U.S. Application Data
(60) Provisional application No. 62/370,026, filed on Aug. 2, 2016.

(51) Int. Cl. A47J 37/06; A47J 27/04; A47J 36/16

(52) U.S. Cl. CPC A47J 37/0641; A47J 2027/043; A47J 36/16; A47J 27/04

(57) ABSTRACT

An air frying system including a housing defining an inner chamber, a food basket removably positionable within the inner chamber, the food basket comprising a shell with first and second ends, a first cap attached to the shell at the first end, and a second cap removably attached to the second end of the shell, and a handle assembly adjacent to the first cap at the first end of the shell. The handle assembly includes a tray having an outer periphery and at least one handle extending from the outer periphery of the tray, wherein at least one of the handles is positioned outside the inner chamber of the housing when the food basket is positioned within the inner chamber of the housing. In this way, the food basket can be inserted and removed from the inner chamber without touching hot surfaces that have been heated during the cooking process.

### CROSS-REFERENCE TO RELATED APPLICATIONS

This application claims priority to and the benefit of U.S. Provisional Patent Application No. 62/370,026, filed Aug. 2, 2016, the entire contents of which is incorporated herein by reference in its entirety.

### TECHNICAL FIELD

The present invention relates generally to cooking appliances for food, and more particularly to an air fryer for cooking food products in a manner that provides a taste, texture and appearance that is similar to what can be achieved by deep frying of those same food products.

### BACKGROUND

Deep frying or deep fat frying is a common method of preparing foods, particular in the restaurant industry. Although large food items can be deep fried, such as fish fillets, multiple relatively small food items can also be deep fried, such as french fries, onion rings, and chicken strips. Such products can be prepared from frozen, refrigerated, room temperature, or partially cooked conditions, depending on the desired final food product.

One drawback to deep frying foods is the need to use large volumes of oil that must be maintained at relatively high temperatures to provide the desired cooking of the products. This hot oil requires special care by the handlers of the food products in order to prevent splashing or spilling of the oil during the cooking processes. In addition, the oil needs to be changed on a regular basis, which can be time-consuming and inconvenient. Although such oil changing is common in the restaurant industry, it can be particularly challenging for individual consumers who are using at-home deep fryers and do not have established procedures for cleaning and oil disposal.

In addition to the inconveniences of deep frying foods, many consumers are becoming more health conscious and therefore are minimizing or eliminating fried foods from their diets. However, some of these same consumers still desire the taste and texture of certain fried foods and are turning to the relatively new cooking process of air frying as a replacement cooking method to deep frying. Air frying eliminates a significant amount of oil and fat absorption into the food products, while maintaining many of the desirable qualities of fried foods.

Commercially available air fryers generally use a basket that must be aligned carefully within an enclosure so that a driving rod mates with its female counterpart. A flap or door on the side of the basket is then opened so that food can be loaded into the air fryer. Hot air is circulated around the food products, thereby cooking the food or “air frying” it. Depending on the product being cooked and the particular air fryer being used, it may be necessary for a portion of the fryer (e.g., the basket) to be periodically shaken to more evenly cook the food items. Once the cooking process is complete, the flap or door is opened and the food product is removed by hand or with a serving utensil, as there is typically not a convenient way to remove the basket from the enclosure without touching hot metal basket surfaces.

While the commercially available fryers may be adequate for certain food preparation processes, there is a desire in the industry to provide additional options for the air frying process to further improve the end food products and simplify the air frying process for the consumer.

### SUMMARY

In an aspect of this invention, an air frying system is provided that includes a housing defining an inner chamber, a food basket removably positionable within the inner chamber, the food basket comprising a shell with first and second ends, a first cap attached to the shell at the first end, and a second cap removably attached to the second end of the shell, and a handle assembly adjacent to the first cap at the first end of the shell. The handle assembly includes a tray having an outer periphery and at least one handle extending from the outer periphery of the tray, wherein at least one of the handles is positioned outside the inner chamber of the housing when the food basket is positioned within the inner chamber of the housing. In this way, the food basket can be inserted and removed from the inner chamber without touching hot surfaces that have been heated during the cooking process.

In another aspect of the invention, an air frying system is provided that comprises a housing defining an inner chamber, a food accessory system comprising at least one cooking component that is removably positionable within the inner chamber, the at least one cooking component comprising a first end plate spaced from and connected to a second end plate, and a handle assembly adjacent to the first end plate. The handle assembly includes a tray having an outer periphery and at least one handle extending from the outer periphery of the tray, wherein at least one of the handles is positioned outside the inner chamber of the housing when the food basket is positioned within the inner chamber of the housing. With this system, the cooking component can be any of a food basket system, a skewer system, or a rotisserie system, for example.

### BRIEF DESCRIPTION OF THE DRAWINGS

The present invention will be further explained with reference to the appended Figures, wherein like structure is referred to by like numerals throughout the several views, and wherein;

FIG. 1 is a perspective view of an exemplary embodiment of an air frying system of the invention in an open position and with a food basket positioned within a housing of the air fryer;

FIG. 2 is a perspective view of the air frying system of FIG. 1 in a closed position;

FIG. 3 is a perspective view of an exemplary embodiment of a food basket for use in an air frying system, including a handle assembly;

FIG. 4 is a partially exploded perspective view of the food basket of FIG. 3;

FIG. 5 is a further exploded perspective view of the food basket of FIGS. 3 and 4;

FIG. 6 is an enlarged top perspective view of a portion of an inner area of an exemplary air fryer, which shows the area in which a food basket fits within the air fryer housing;

FIG. 7 is a perspective view of an exemplary embodiment of an air frying system of the invention in an open position and with a skewer assembly positioned therein;

FIG. 8 is a perspective view of a skewer assembly for use within an air fryer of the type illustrated in FIG. 7;

FIG. 9 is a side view of the skewer assembly of FIG. 8;

FIG. 10 is a perspective view of one exemplary skewer that can be used in a skewer assembly of the type illustrated in FIGS. 8 and 9;

FIG. 11 is a perspective view of an exemplary embodiment of an air frying system of the invention in an open position and with a rotisserie accessory positioned therein;

FIG. 12A is a perspective view of an exemplary food basket for use in an air fryer, including a handle assembly having a push-button release that is connected to the food basket;

FIG. 12B is a perspective view of the food basket and handle assembly of FIG. 12A, with the handle assembly removed from the basket after the push-button release has been utilized;

FIG. 13A is a perspective view of a model of a food basket of the invention in a filling position and having an open end that seals or closes against a solid end plate of the air fryer;

FIG. 13B is a perspective view of the model of a food basket illustrated in FIG. 13A, with the food basket in a position in which it can be engaged with the solid end plate of the air fryer;

FIG. 14 is a perspective view of an exemplary embodiment of an air frying system having a food basket positioned therein;

FIG. 15 is a perspective solid model illustration of an exemplary embodiment of a cap driven driving mechanism for an air frying system having a food basket; and

FIG. 16 is a perspective solid model illustration of an exemplary embodiment of a gear driven mechanism for an air frying system having a food basket.

### DETAILED DESCRIPTION

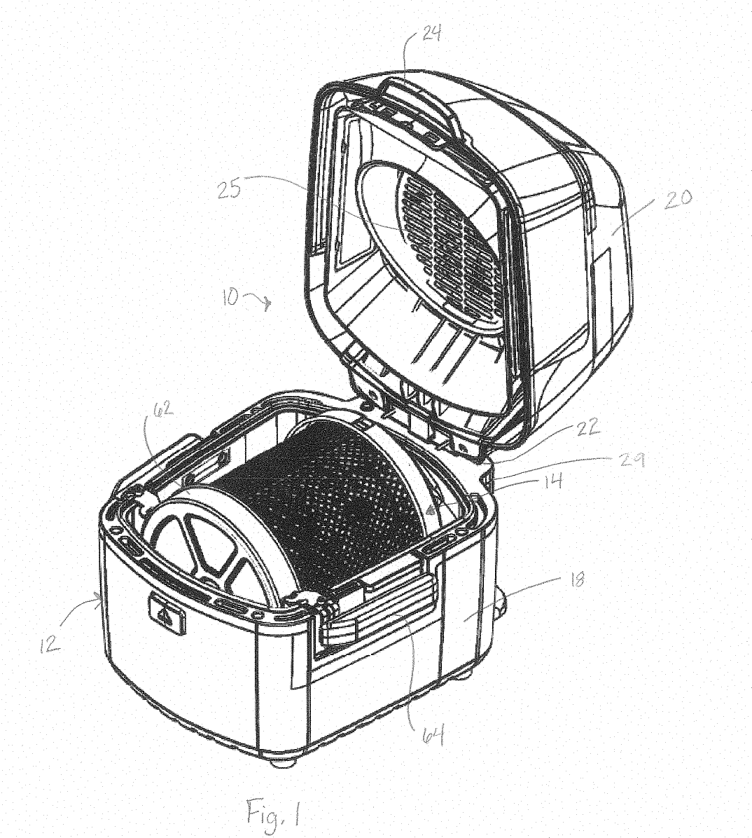

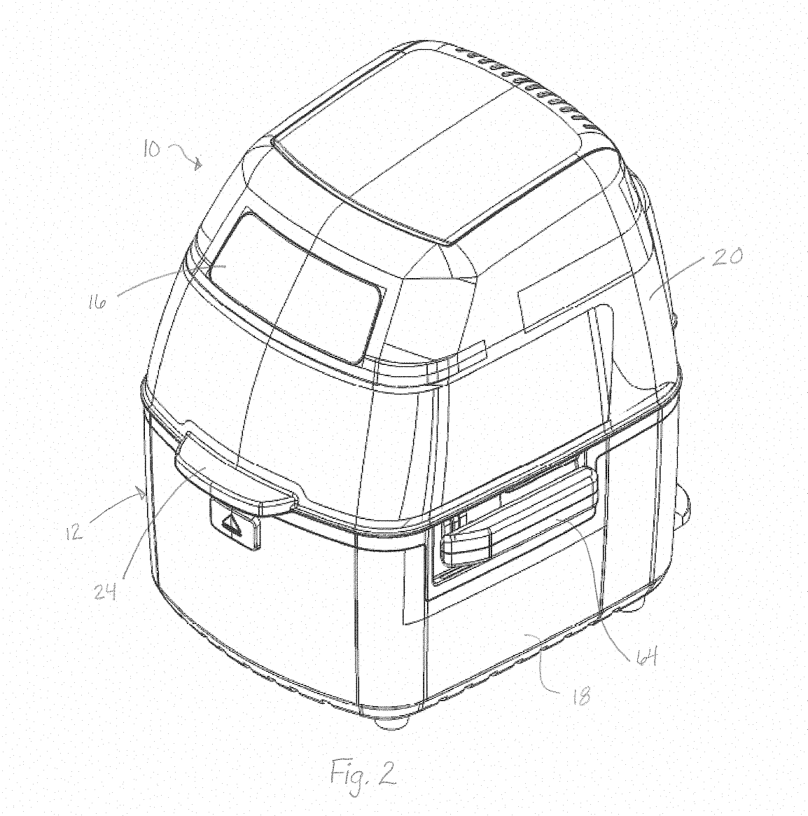

Referring now to the Figures, wherein the components are labeled with like numerals throughout the several Figures, and initially to FIGS. 1 and 2, a first exemplary configuration of an air fryer or air frying system 10 is illustrated. Air fryer 10 generally includes a housing 12 that surrounds the internal components of the air fryer, including a removable and rotatable food basket 14 that can be driven by a motor (not visible in these figures) or manually. FIG. 1 illustrates the housing 12 in an open position and FIG. 2 illustrates the same housing in a closed position in which the air frying operation can take place.

Housing 12 generally includes a shell with an inner cavity having a number of pieces to allow both for assembly of the housing and for access to certain portions of the housing. As illustrated, housing 12 includes a bottom or base portion 18 to which a top or moveable portion 20 is attached via a hinge 22. Top or moveable portion 20 includes a handle 24 that can optionally be provided for ease in opening and closing the air fryer. At least part of the top portion 20 can include a transparent or partially transparent window 16 to allow for viewing of the food product as it is cooking, although all or part of the top portion 20 can be opaque and/or translucent. It can be advantageous for the top portion 20 to be configured so that it remains in its open position without tipping the housing 12 during the loading and unloading of basket 14, and so that it locks or otherwise positively engages with the bottom portion 18 when it is closed. The top portion 20 does not necessarily need to be hinged relative to the bottom portion 18, however, but can instead be attached in a different manner and/or at a different edge of the housing 12.

In an embodiment of the invention, the housing is configured so that the bottom portion 18 can sit on a horizontal surface without tipping when the top portion 20 is in both its open and closed position. In this way, the accessories with uncooked food products can be easily loaded into the housing 12 and then removed from the housing 12 after cooking without difficulty, and the air fryer 10 can remain on a horizontal surface during the air frying operation.

When the top portion 20 is in its open position, an operator can access the inner area of the housing 12, such as to move the food basket 14 and/or other accessories into and out of the inner area of the housing 12. The top portion 20 includes a heater and fan (neither of which is visible) behind a vented area 25, which provides the desired heated air and directs it into the inner area of the housing 12 to cook the enclosed food. The heater may include any of a number of different types of devices that heat the air to a desired temperature for cooking. For one example, the heater may include one or more separate elements, including quartz tube heaters, wound mica heaters, halogen tube heaters, or other types of heaters (e.g., tubular heaters), such as those available under the trade name “Calrod”. In an exemplary embodiment, these heater elements are used to produce radiant heat within the housing 12.

A fan (e.g., a centrifugal fan) is positioned relative to the heater elements in a location in which it circulates the heated air through the housing 12. The fan directs air generally around the top and bottom of inner volume of the housing 12. In one embodiment, the heated air will be directed around the perimeter of the housing, after which it is drawn up through the food basket 14. Some of the air will then be recirculated within the housing 12 and any excess heated air can be vented or evacuated through a vented area 29. In this embodiment, the vented area 29 is located adjacent to the back or hinged area of the housing 12, but it could instead be at a different area of the housing 12. The speed of the fan is controllable to allow for adjustment of the movement of the heated air along its path. The speed of this fan can be directly or indirectly correlated to the amount of food in the food basket 14, if desired, in order to achieve a certain cooking of the food product. The air fryer 10 can be provided with automatic and/or manual settings to adjust these parameters.

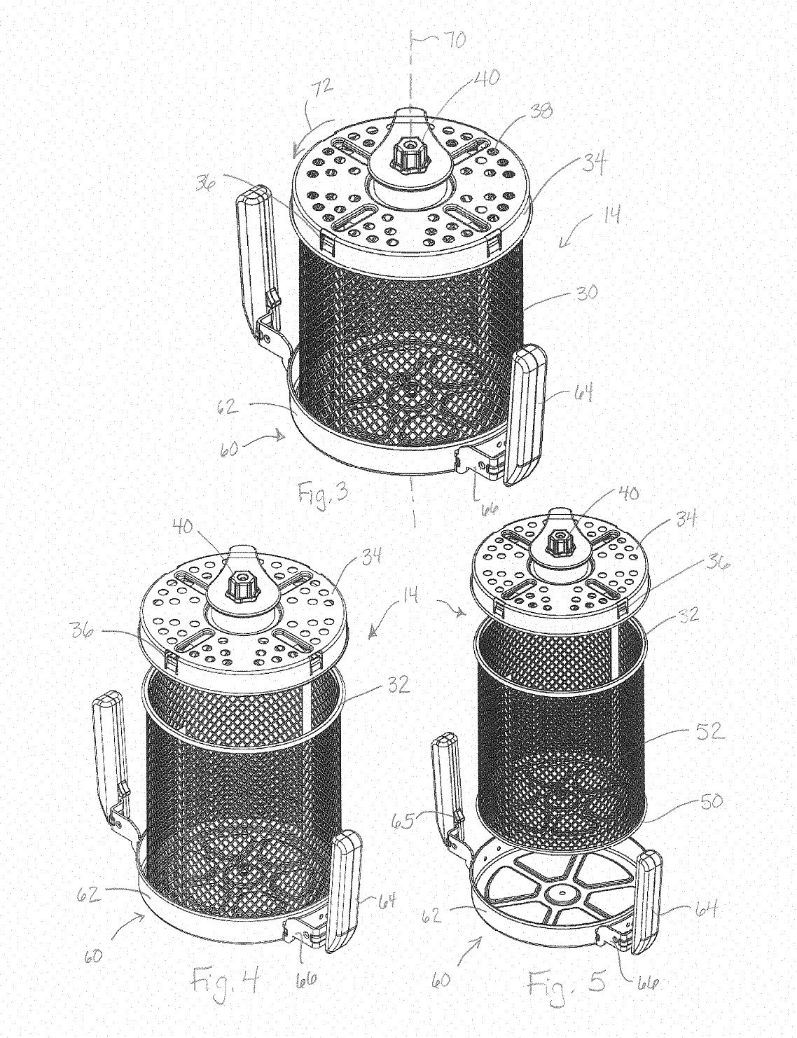

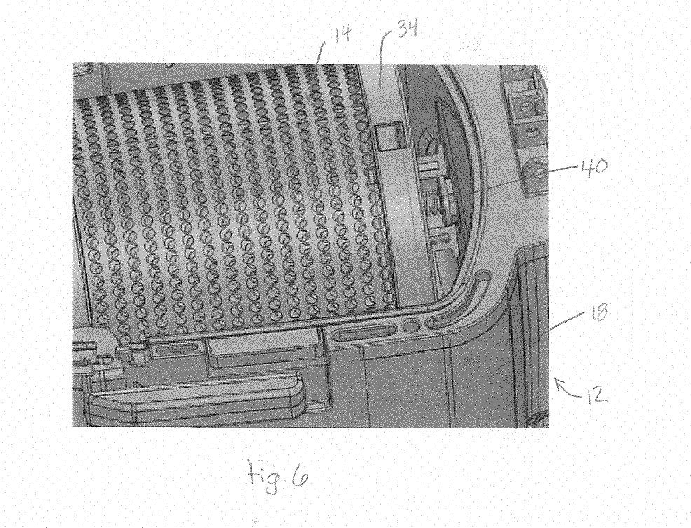

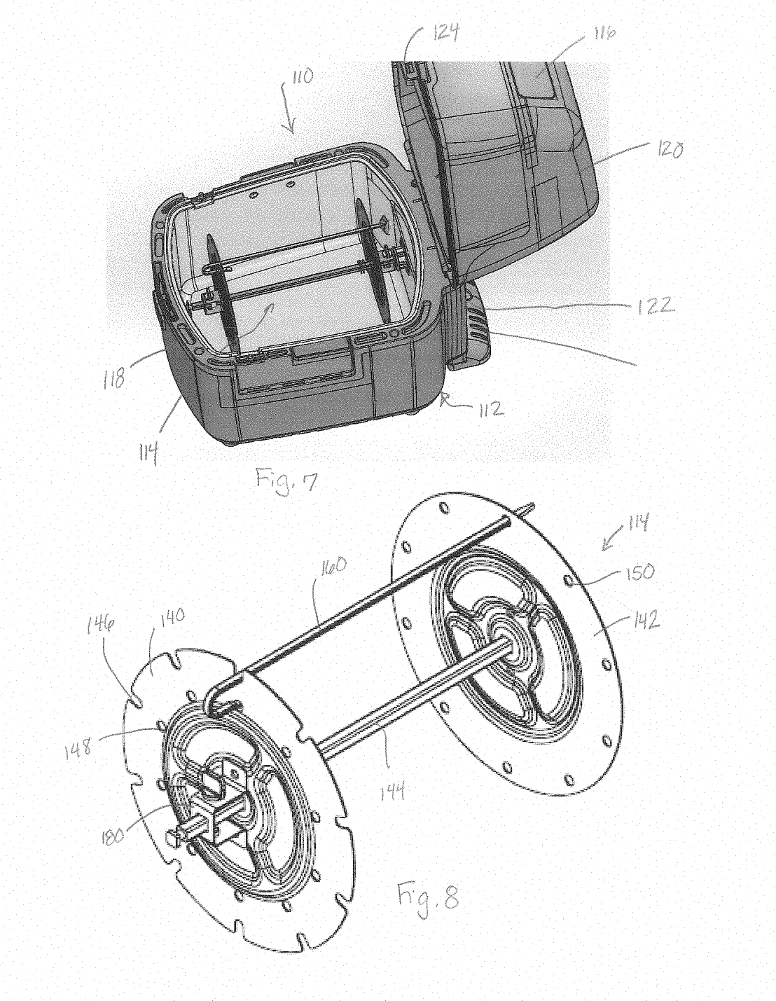

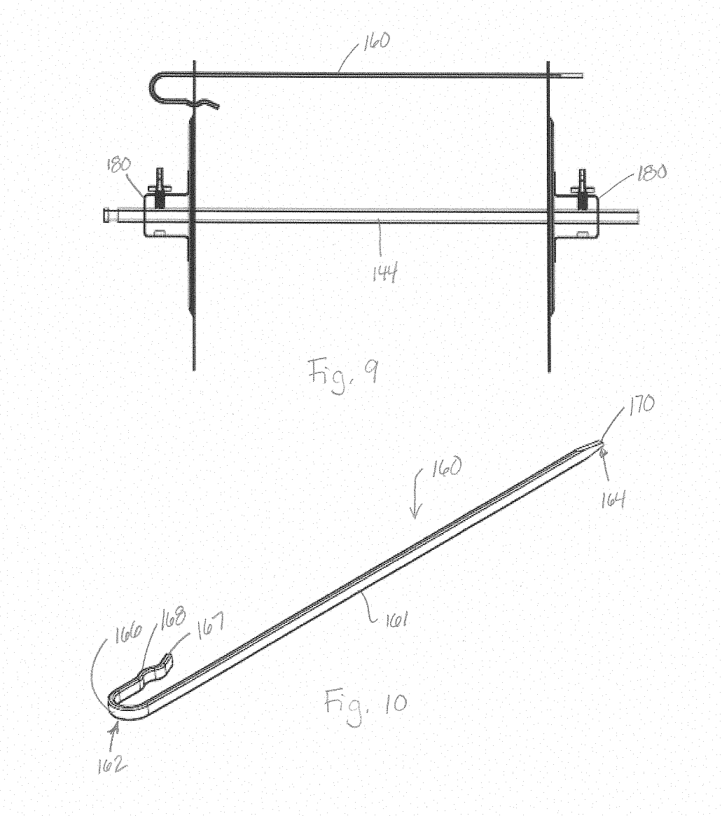

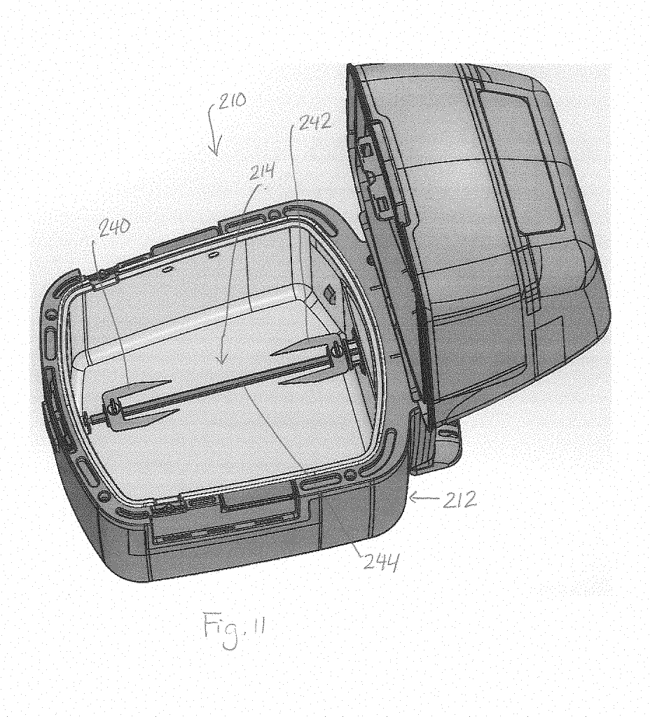

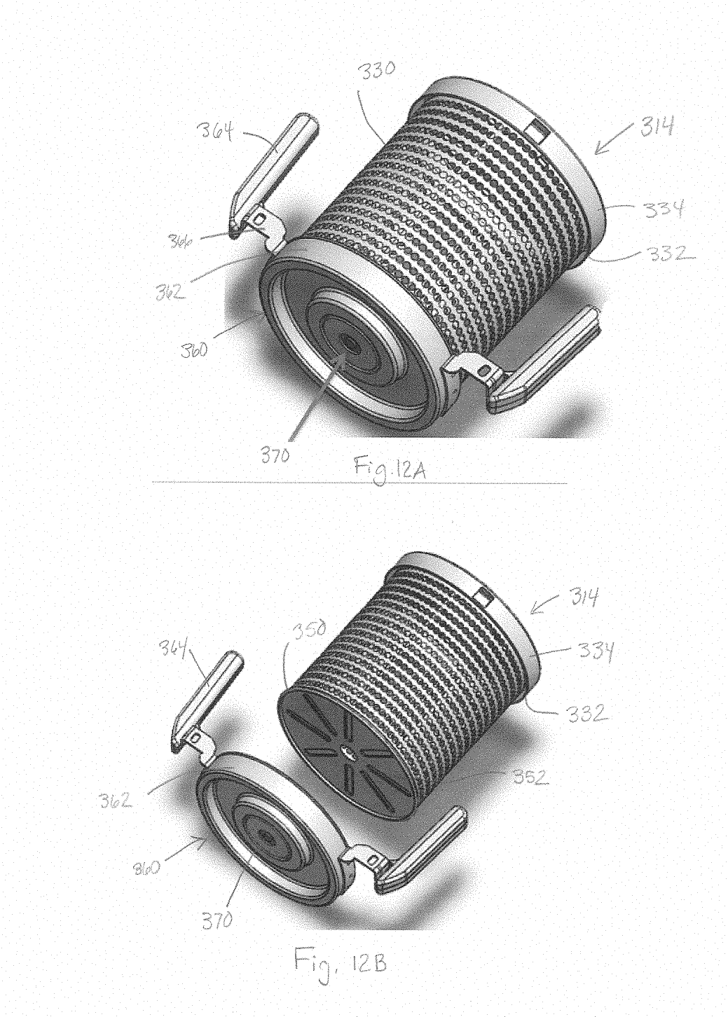

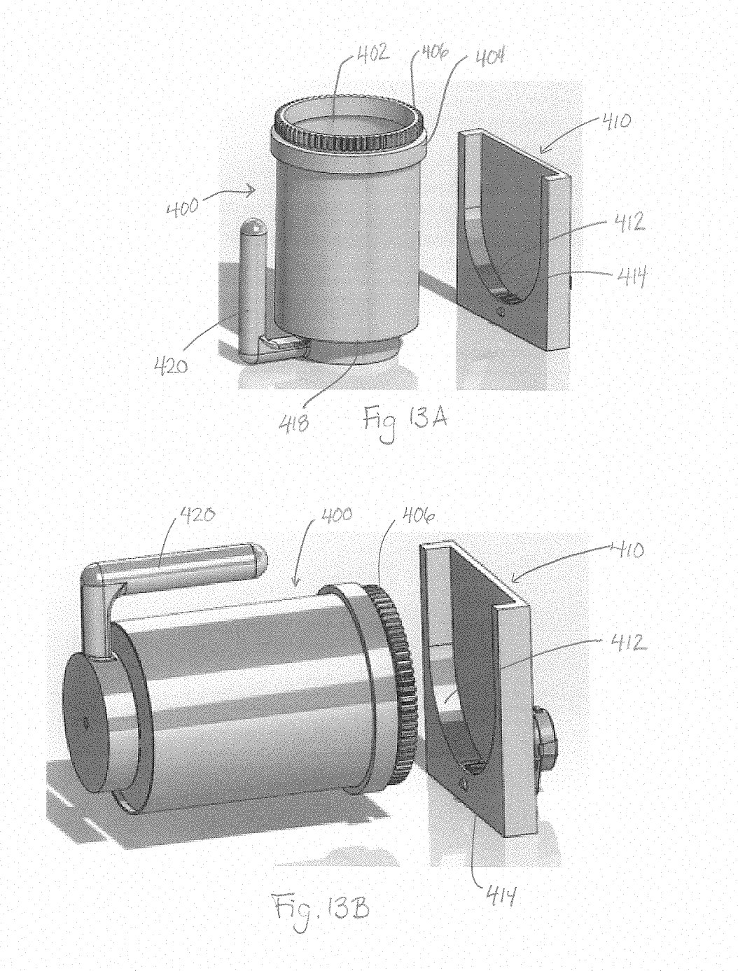

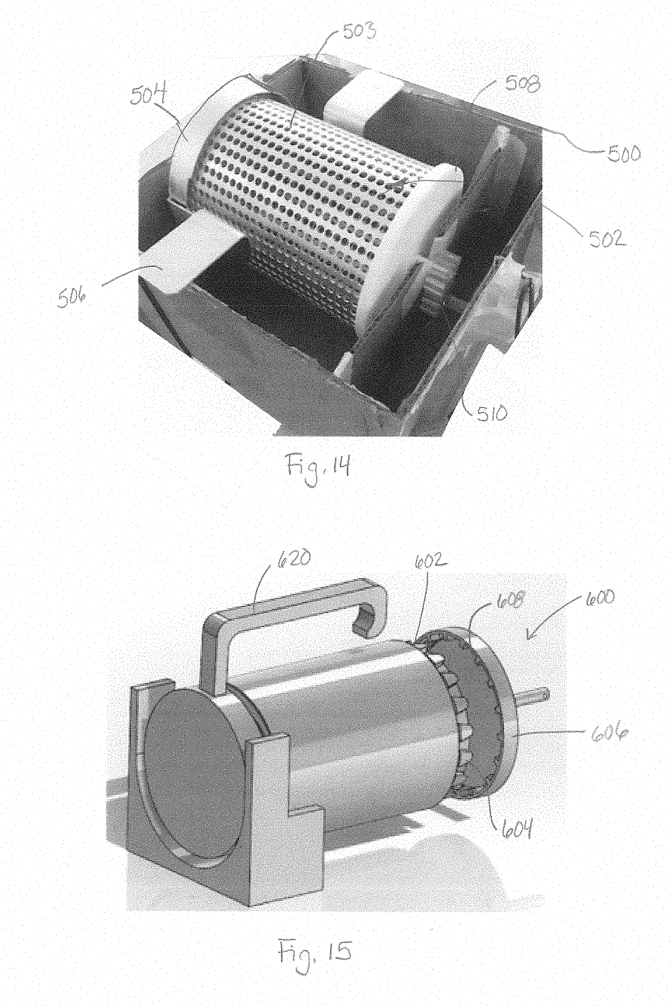

Referring additionally to FIGS. 3-5, an embodiment of food basket 14 includes a cylindrical container with an inner area that is sufficiently large to hold a specified quantity of food. FIG. 3 shows the basket 14 in an assembled condition, FIG. 4 shows the basket 14 in a partially disassembled condition, and FIG. 5 shows the basket 14 in a further disassembled condition. The basket 14 includes an outer shell 30 that is made of a perforated or mesh material, such as a metal mesh. A first end 32 of the shell 30 is open for accepting food being loaded into the food basket. An end cap 34 is provided that can engage with the first end 32 in a number of ways, including engagement of tabs 36 on the cap 34 with the first end 32 of shell 30 by pressing the end cap 34 onto the first end 32. Alternatively, the end cap 34 may have more, less, or no tabs, wherein the end cap 34 could instead include a channel into which the first end 32 can be pressed, for example. In yet another exemplary alternative, the first end 32 and the end cap 34 can include other mating fasteners or may include mating threaded surfaces so that the end cap 34 can be screwed onto the first end 32. In any case, the engagement of the end cap 34 and the first end 32 should be sufficiently secure so that the components do not become unintentionally disengaged from each other.

End cap 34 includes a number of perforations 38 through which air and moisture can exit the basket 14 during the air frying operation. The perforations 38 may be positioned in a pattern or in a random arrangement, and the number and location of perforations 38 can be different from that shown. Each perforation 38 will generally be large enough to allow a desired amount of air and moisture to be evacuated from the basket 14, but will generally be small enough to prevent any of the food pieces to unintentionally exit the basket 14.

End cap 34 further includes a coupling 40 extending from its outer surface and positioned along an axis about which the basket 14 rotates, as will be described in further detail below relative to positioning of the basket 14 within the housing 12. Coupling 40 can be a hex member with flat sides, as shown, or can be a different shape or size for engagement with a mating structure.

The cylindrical shell 30 further includes a second end 50 opposite the first end 32. A plate 52 is attachable to the second end 50, which can be a flat or contoured surface to seal or close the second end of the shell 30 and provide a surface onto which food placed within the basket 14 will rest when the basket 14 is in the position shown in FIGS. 3-5. The center of the plate 52 generally aligns with a center of the coupling 40 at the opposite end of the basket 14.

Air fryer 10 further includes a handle assembly 60 that is attachable to the second end 50 of the shell 30. Handle assembly generally includes a tray 62 from which at least one handle 64 extends. In this embodiment, two of such handles 64 are provided, which extend from opposite sides of the tray 62. However, it is understood that more or less than two handles can be provided, and that they can be positioned at various locations around the outside edge of the tray 62. An intermediate bracket or spacer 66 can extend between the tray 62 and the handle 64, or the bracket or spacer 66 can instead be integrated into the handle 64. In any case, each handle 64 is spaced from the tray 62 so that it can fit into the housing 12 in accordance with the description below. In addition, each handle 62 can optionally include a projecting stop member 65 or different feature that can help to keep the user's hands positioned near the distal end of the handles 62.

Referring again to FIGS. 1 and 2, handle assembly 60 is configured so that handles 64 will fit into slots or recesses in the housing 12. In this way, the operator will be able to place the food basket 14 into the housing 12 without contacting the inner area of the housing 12. Such a configuration can be particularly advantageous when removing the food basket 14 after the cooking process (when the basket 14 and its contents are hot) because the handles 64 are outside the inner area of the housing during the cooking operation. Thus, the handles 64 will remain relatively cool and can immediately be grasped by the user as soon as it is desired to take the food basket 14 from the housing 12.

Referring again to FIG. 3, food basket 14 has an axis 70 about which it can rotate relative to the housing 12 during the food cooking process. Food basket 14 may be connected to handle assembly 60 in the center of its tray 62 and along that same axis 70. Movement of the basket 14 relative to the housing is shown as being a rotation about the axis 70 in a direction represented by arrow 72. The motion can be reversible so that the basket 14 can also be rotated in the opposite direction. In any case, the basket 14 is designed so that it can freely rotate within housing 12 with sufficient clearance and also rotate relative to the tray 62 of handle assembly 60.

The basket 14 of this embodiment and others described herein can instead have a different configuration than the cylindrical shape shown (e.g., a different shape and/or size) that still allows for rotation generally as described. The mesh of the basket can be relatively dense or loose, depending on the desired amount of access to hot air that is desired within the basket itself. The basket may instead be made of materials other than mesh, such as a solid material sheet with perforations, for example, or other materials.

Rotation of the food basket 14 about the axis 70 can be driven by a motor that includes a belt or a gearing system, for example. The motor is preferably adjustable by the operator to control the desired speed of rotation for the basket 14. The food basket 14 can alternatively or additionally be manually rotated to agitate the food contained in the basket.

FIG. 6 is a partial enlarged view of an inner area of an air fryer, which shows the area in which food basket 14 fits within the inner area of housing 12, or more particularly within the bottom or base portion 18. Coupling 40 extends from the outer surface of end cap 34 and is spring-loaded so that it can be compressed during insertion into the housing 12 and so that it can extend when assembled, as shown in FIG. 6. This non-rigid design advantageously allows more flexibility for the insertion of the basket 14 into housing 12 because the basket 14 can be at least slightly misaligned with the male acceptor into which it is placed, then will be properly seating after release of the compressed coupling 40.

FIG. 7 is a perspective view of another exemplary embodiment of an air frying system 110 of the invention that is similar or the same as the air frying system 10 discussed above relative to FIG. 1, but includes an assembly used for cooking food on skewers rather than in a basket. In accordance with the invention, the air frying systems can include provisions for using the same basic housing structure with multiple cooking accessories, including the food basket 14 described above, the skewer system that will be described below, and/or additional cooking accessories. Alternatively, a single air frying system may only accommodate a single cooking accessory (e.g., a food basket).

Air fryer 110 generally includes a housing 112 that surrounds the internal components of the fryer, including skewer assembly 114 that may be driven by a motor (not visible in these figures) or by hand. FIG. 7 illustrates the housing 112 in an open position, which is the configuration in which the skewer assembly 114 can be inserted into and removed from the housing 112.

Housing 112 generally includes a shell with an inner cavity having a number of pieces to allow both for assembly of the housing and for access to certain portions of the housing. As illustrated, housing 112 includes a bottom or base portion 118 to which a top or moveable portion 120 is attached via a hinge 122. Top or moveable portion 120 includes a handle 124 that can optionally be provided for ease in opening and closing the air fryer. At least a portion of the top portion 120 can include a transparent or partially transparent window 116 to allow for viewing of the food product as it is cooking, although all or portions of the top portion 120 can be opaque and/or translucent. It can be advantageous for the top portion 120 to be configured so that it remains in its open position during the loading and unloading of skewer system 114 without causing the air fryer 110 to tip, and so that it locks or otherwise positively engages with the bottom portion 118 when it is closed. The top portion 120 does not necessarily need to be hinged relative to the bottom portion 118, however, but can instead be attached in a different manner and/or at a different edge of the housing 112.

When the top portion 120 is in its open position, an operator can access the inner area of the housing 112, such as to move the skewer system 114 and/or other accessories into and out of the inner area of the housing 112. The top portion 120 includes a heater and fan (neither of which is visible) behind a vented area 125, which provides the desired heated air and directs it into the inner area of the housing 112 to cook the enclosed food.

A fan (e.g., a centrifugal fan) is provided generally adjacent to the heater elements to circulate the heated air through the housing 112. The fan directs air generally around the top and bottom of inner volume of the housing 112. In one embodiment, the heated air will be directed around the perimeter of the housing, after which it is drawn up and around the skewer assembly 114. Some of the air will continue to be recirculated within the housing 112 and any excess heated air can be vented or evacuated through a vented area 129. In this embodiment, the vented area 129 is located adjacent to the back or hinged area of the housing 112, but it could instead be at a different area of the housing 112. The speed of the fan is controllable to allow for adjustment of the movement of the heated air along its path. The speed of this fan can be directly or indirectly correlated to the amount of food and skewers on the skewer assembly 114, if desired, in order to achieve a certain cooking of the food product. The air fryer 110 can be provided with automatic and/or manual settings to adjust these parameters.

Referring additionally to FIGS. 8 and 9, different views are shown of the skewer assembly 114 separate from the housing 112. Skewer assembly 114 generally includes a first plate 140 spaced from a second plate 142, a shaft 144 extending between the first and second plates 140, 142, and at least one skewer rod 160 engaged with the first and second plates 140, 142. First plate 140 includes at least one notch 146 along its peripheral edge and at least one hole 148 associated with each of the notches 146. Second plate 142 includes at least one hole 150 that also corresponds with one of the notches 146. In this configuration, each skewer rod 160 that is being used in the air fryer 110 will be able to engage with one notch 146, one hole 148 in the first plate 140, and one hole 150 in the second plate 142.

In the exemplary embodiment illustrated most clearly in FIG. 10, skewer rod 160 includes an elongated member 161 having a proximal end 162 and a distal end 164. Proximal end 162 includes a hook-shaped member 166 that includes an end 167 and a number of contours, including an arched portion or detent 168. Distal end 164 includes a distal tip 170 that is at least slightly tapered or pointed for ease in penetrating food products that are to be cooked in the air fryer 110.

One skewer rod 160 is illustrated as being mounted in the skewer assembly 114, but it is understood that multiple skewer rods 160 can be mounted in the skewer assembly 114. In the illustrated embodiment, between one and ten skewer rods 160 can be mounted in the skewer assembly 114. In order to mount each skewer rod 160 in the skewer assembly 114, distal end 164 of skewer rod 160 is moved toward the second plate 142 while keeping the remainder of the skewer rod 160 aligned with one of the notches 146 of the first plate 140. As distal tip 170 is pushed into one of the holes 150 in second plate 142, the end 167 of hook-shaped member 166 will similarly be pushed into one of the holes 148 in first plate 140. In an embodiment, the arched portion or detent 168 will engage or “click” with the hole 148 in order to more securely attach the proximal end 162 of the skewer rod 160 to the first plate 140. Because each notch 146 is associated with one of the holes 148, the skewer rod 160 will be resting in one of the notches 146 when the detent 168 is engaged with one of the holes 148 in the first plate 140 and the distal tip 170 has been pushed at least partially through one of the holes 150 in second plate 142.

The skewer rods used with skewer assemblies of the invention can be configured differently than illustrated herein, however, wherein any of such embodiments can include end plates with corresponding different structures to engage with a skewer rod and lock it securely in place. It is desirable that the engagement of skewer rods with end plates or other structures is relatively easy to do for skewer removal once the air frying operation is complete.

Shaft 144 of skewer assembly 114 is shown as extending through a central opening in each of the end plates 140, 142, and further includes a securing bracket 180 at both ends to keep the shaft 144 secured to the end plates 140, 142. Ends of the shaft 144 are configured for engagement within the housing 112 after the desired number of skewer rods 160 are secured to the end plates 140, 142. The entire skewer assembly 114 can rotate within the housing 112, such as with a motor, or can stay stationery within the housing 112 during the air frying process.

FIG. 11 is a perspective view of an exemplary embodiment of an air frying system or air fryer 210 of the invention in an open position and with a rotisserie assembly 214 positioned therein. Air fryer 210 is similar in many ways to embodiments of air fryers 10 and 110 discussed above, and generally includes a housing 212 that surrounds the internal components of the fryer, including rotisserie assembly 214. When housing 212 is in its open position, an operator can access its inner area, such as to move the rotisserie system 214 and/or other accessories into and out of the inner area of the housing 212.

Rotisserie assembly 214 generally includes a first fork member 240 spaced from a second fork member 242, and an elongated shaft 244 extending between the fork members 240, 242. A relatively large food product can be penetrated at opposite ends by the first and second fork members 240, 242 to hold it in place relative to the shaft 244 that will run through a length or width of the food product. Ends of the shaft 244 are configured for engagement within the housing 212 so that the entire rotisserie assembly 214 can rotate within the housing 212, such as by engagement with a motor, or can stay stationery within the housing 212 during the air frying process.

FIGS. 12A and 12B are assembled and disassembled views, respectively, of an exemplary food basket 314 for use in an air fryer in accordance with embodiments of the invention, and including a handle assembly having a push-button release that is connected to the food basket, but could also be attachable to other accessories such as skewer assemblies, rotisserie assemblies, and the like. As with other food baskets described herein, basket 314 is a container with a sufficiently large inner area to hold a specified quantity of food. Basket 314 includes an outer shell 330 that is made of a perforated or mesh material. A first end 332 of the shell 330 can be opened for the loading of food products into the food basket. An end cap 334 is engageable with the first end 332 of the shell 330 so that the components do not become unintentionally disengaged from each other. Shell 330 further includes a second end 350 opposite the first end 332. Second end 350 includes a plate 352, which can be a flat or contoured surface, and which seals that end of basket 314 to provide a surface onto which food within the basket 314 will rest when the basket is being filled.

Air fryer 310 further includes a handle assembly 360 that is attachable to the second end 350 of the shell 330. Handle assembly generally includes a tray 362 from which at least one handle 364 extends. In this embodiment, two of such handles 364 are provided, which extend from opposite sides of the tray 362. An intermediate bracket or spacer 366 can extend between the tray 362 and the handle 364, or the bracket or spacer 366 can instead be integrated into the handle 364. In any case, each handle 364 will generally be spaced from the tray 362 so that it can fit into a corresponding housing with the handles remaining outside of the cooking chamber during the air frying operation.

In order to easily remove the shell 330 from the handle assembly 360, a push-button release member 370 is provided on the outer surface of the tray 362. Release member 370 can be pressed to disengage a connecting mechanism of the tray 362 from an outer surface of the second end 350 of the shell, then can be pushed back toward the tray 362 for reengagement of the connection between the two components.

FIGS. 13A and 13B illustrate a solid model of an embodiment of a food basket 400 for use in an air fryer. For this and other figures shown and described herein that show the food basket as a having a solid or smooth outer surface, it is understood that the cylindrical portion of the basket will generally instead be a mesh or perforated material that allows the circulation of heated air through it. That is, the illustrated solid surface is intended to encompass materials that are not solid. In this embodiment, food basket 400 includes an open end 402 into which food can be inserted, which will typically be done when the food basket is in the position illustrated in FIG. 13A. An end cap 404 is attached at the open end that includes a geared surface 406 around its periphery. Food basket 400 further includes a closed or sealed end 418 that is opposite the open end 402, and can also include one or more handles 420 that are configured for positioning relative to a housing in manners discussed herein relative to air fryer housings.

This embodiment further includes an end plate 410 that will typically be a vertically positioned surface within a housing in which the food basket 400 is inserted. End plate 410 includes a U-shaped channel 412 that is configured so that the open end 402 of food basket 400 can be inserted and removed by sliding the basket 400 into the channel 412, thereby providing a top surface to close the basket 400. The U-shaped channel 412 includes a gear 414 that is positioned for engagement with the geared surface 406 of food basket 400 when the basket is rotated to be horizontal (as in FIG. 13B) and slid into channel 400. Rotation of the basket 400 will be controlled by a motor that drives the gear 414.

FIG. 14 is a perspective view of an exemplary embodiment of an air frying system having a housing 500 in which a food basket 502 is positioned. Food basket 502 includes mesh or perforated body 503 with a handle assembly 504 at its sealed end. The handle assembly 504 of this embodiment includes at least one handle 506 that optionally extends at least slightly outside the housing 500. The end of the body 503 that is opposite the handle assembly 504 will be the end into which food can be inserted and sealed with an end cap 508. Cap 508 further includes an extending gear 510 that is engageable with a gear of a motor that will be used to rotate the food basket 502 within the housing 500.

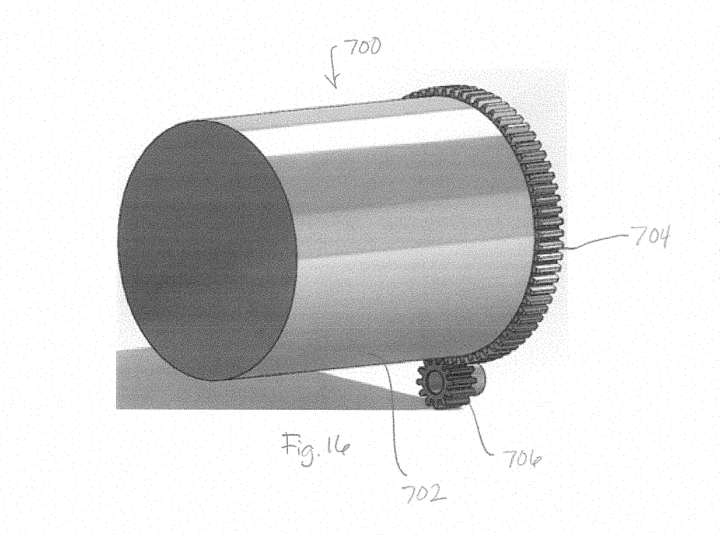

FIG. 15 illustrates a solid model of an embodiment of a food basket 600 for use in an air fryer, which includes an open end 602 into which food can be inserted and further includes an outer surface having multiple protrusions 604. These protrusions 604 are engageable with notches or recesses 608 in the periphery of a cap 606 that also seals the open end 602 of the basket 600. Cap 606 is rotated either manually or with a motor or other device to cause rotation of the food basket 600. Food basket 600 can also include one or more handles 620 that are configured for positioning relative to a housing in manners discussed herein relative to air fryer housings.

FIG. 16 illustrates a solid model of an embodiment of a food basket 700 for use in an air fryer, which includes a body or container 702 for food and an outer geared surface 704 at one of its ends. The geared surface 704 is driven by a small gear 706 that causes rotation of the food basket 700 when it is positioned in an air fryer.

Air fryers of the invention can additionally incorporate steam into the air fryer housings. In particular, air fryers described herein can additionally have the ability to add steam to food products before, after, and/or during the process of cooking the food. In particular, the air fryer systems and methods provide for steam cooking and air frying in a single device or air frying unit. For an example, steam can be used in an initial step of cooking a food product, and then the steam can be evacuated or allowed to exit the device, such as through vents in the back of the air fryer housing. The air frying step can then take place to “crisp” or otherwise air fry the food products. However, these steps can instead be performed in a different order and/or one or more steps can be repeated, if desired. The amount of steam provided to the food products can be controlled and monitored, depending on the food being cooked and the desired qualities desired for the end food product. The timing of steam introduction to the system can also be controlled and monitored.

Although certain features are described generally herein relative to particular embodiments of the invention, it is understood that the features are interchangeable between embodiments to arrive at a single air frying system that includes features of different illustrated embodiments. It is further understood that the assembly and cooking steps described above can instead be performed in a different order and/or the steps can be repeated, if desired. The amount of heated air provided to the food products can be controlled and monitored to provide varying cooking results, depending on the food being cooked and the desired qualities desired for the end food product. The timing of when the heat is introduced within the system can also be controlled and monitored.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

What is claimed is:

1. An air frying system comprising:
a housing defining an inner chamber;
a food basket removably positionable within the inner chamber, the food basket comprising a shell with first and second ends, a first cap attached to the shell at the first end, and a second cap removably attached to the second end of the shell; and
a handle assembly adjacent to the first cap at the first end of the shell, the handle assembly comprising:
a tray having an outer periphery; and
at least one handle extending from the outer periphery of the tray;
wherein at least one of the handles is positioned outside the inner chamber of the housing when the food basket is positioned within the inner chamber of the housing.

2. The air frying system of claim 1, wherein the housing comprises a top portion positioned above a base portion, wherein at least one of the top portion and the base portion comprises at least one handle acceptor portion in which the at least one handle can be positioned when the food basket is positioned within the inner chamber of the housing.

3. The air frying system of claim 1, wherein the second cap comprises a perforated surface.

4. The air frying system of claim 1, wherein the handle assembly comprises at least two handles that are spaced from each other around the outer periphery of the tray.

5. The air frying system of claim 1, wherein the tray is rotatably attached to the first cap so that the food basket is rotatable within the inner chamber relative to the handle assembly.

6. The air frying system of claim 1, wherein the tray is releasably attached to the first cap.

7. The air frying system of claim 1, further comprising at least one of a skewer assembly and a rotisserie assembly removably positionable within the inner housing.

8. The air frying system of claim 1, wherein the food basket is operatively connected to a driving mechanism for rotating the food basket about a longitudinal axis.

9. The air frying system of claim 1, further including at least one heating element and at least one fan for circulating heated air within the inner chamber.

10. The air frying system of claim 9, wherein the at least one fan directs the heated air along a path from the heating element around a perimeter of the inner chamber and then into the food basket through the shell.

11. The air frying system of claim 1, further comprising a steam supply system for providing steam to the inner chamber of the housing.

12. The air frying system of claim 1, wherein the housing further comprises a vented area through which excess air from the inner chamber can exit the housing.

13. An air frying system comprising:
a housing defining an inner chamber;
a food accessory system comprising at least one cooking component that is removably positionable within the inner chamber, the at least one cooking component comprising a first end plate spaced from and connected to a second end plate; and
a handle assembly adjacent to the first end plate and comprising:
a tray having an outer periphery; and
at least one handle extending from the outer periphery of the tray;
wherein at least one of the handles is positioned outside the inner chamber of the housing when the food basket is positioned within the inner chamber of the housing.

14. The air frying system of claim 13, wherein the at least one cooking component comprises at least one of a food basket system, a skewer system, and a rotisserie system.

15. The air frying system of claim 13, wherein the at least one cooking component comprises a skewer system that comprises:
a first end plate comprising at least one notch on a peripheral edge;
a second end plate spaced from and operatively connected to the first end plate, wherein the second end plate comprises at least one aperture; and
at least one skewer comprising:
a distal end that is insertable through one of the at least one apertures; and
a proximal end that is engagable with the at least one notch.

16. The air frying system of claim 15, wherein the at least one notch comprises multiple notches, wherein the at least one aperture comprises multiple apertures, wherein the at least one skewer comprises multiple skewers, and wherein each of the multiple skewers is engagable with one of the multiple notches and one of the multiple apertures.
